(19) United States
(12) Patent Application Publication
(10) Pub. No.: US 2022/0251272 A1
(43) Pub. Date: Aug. 11, 2022

(54) POLY (ETHYLENE-VINYL ACETATE) COPOLYMER WITH NON-SPECIFIC SPATIAL CONFIGURATION, METHOD FOR ITS PREPARATION AND USE

(71) Applicant: CHEMICAL INNOVATION LTD., Sofia (BG)

(72) Inventor: Kamen Yordanov ARSOV, Batanovtsi (BG)

(73) Assignee: CHEMICAL INNOVATION LTD., Sofia (BG)

(21) Appl. No.: 17/629,193

(22) PCT Filed: Jul. 7, 2020
(86) PCT No.: PCT/BG2020/000026

§ 371 Date: Jan. 21, 2022

(30) Foreign Application Priority Data
Jul. 19, 2019 (BG) 112969

(51) Int. Cl. C08F 255/02; C08L 23/08

(52) U.S. Cl. CPC C08F 255/02; C08L 2207/066; C08L 2207/062; C08L 23/0853

(57) ABSTRACT

A new poly (ethylene-vinyl acetate) copolymer with a non-specific spatial configuration of the vinyl acetate units with respect to the main ethylene chain. Also, a method for its production through addition polymerization of polyethylene and vinyl acetate and to its use. The new poly (ethylene-vinyl acetate) copolymer will find application in various branches of the chemical industry and construction.

### FIELD

The invention refers to a new poly (ethylene-vinyl acetate) copolymer with a non-specific spatial configuration of the vinyl acetate units with respect to the main ethylene chain and to a method for its production, which will find application in various branches of the chemical industry and construction.

### BACKGROUND

The emulsion copolymerization between ethylene and vinyl acetate at high pressures of 1000 to 3000 atmospheres, temperatures up to 300° C. and azo-containing initiators such as 2,2-azobis-(2,4-dimethylvaleronitrile), 2,2-azobis-(2,4,4-trimethyl-valeronitrile), 2,2-azobis-(4-methoxy-2,4-dimethylvaleronitrile), etc. is considered to be a classic method for the poly (ethylene-vinyl acetate) copolymer production).

U.S. Pat. No. 2,703,794 presents a method for EVA production by emulsion polymerization using an oxy-reduction catalyst system, which is a mixture of organic and inorganic substances, at low temperatures up to 30° C. and pressure of 1000 bar, followed by a pressure drop to 120 bar.

U.S. Pat. No. 3,325,460 describes a continuous process of EVA copolymers production by polymerization of ethylene and vinyl acetate in series-connected vessels, in butanol medium and at temperatures of 20° C. to 120° C., in which organic peroxides, benzoyl peroxide, lauryl prooxide and azodiisobutyronitrile are used as catalysts.

U.S. Pat. No. 4,035,329 describes a method for continuous EVA copolymers production by polymerization of ethylene and vinyl acetate in an aqueous medium containing emulsifiers and protective colloid. The reaction is carried out at temperatures up to 100° C. and pressures up to 100 bar, using peroxides, alkaline persulphates and metal salts with transient valence as catalysts.

U.S. Pat. No. 4,657,994 reveals a method for EVA production with molar ethylene content of 20 to 50%, by emulsion polymerization using an aliphatic alcohol solvent, where the ethylene vapors released from the reaction mixture in a polymerization reactor are introduced into the bottom of a multi-tube heat exchanger, in the upper part of which vinyl acetate is introduced, thus absorbing and dissolving ethylene in vinyl acetate. The solubilized ethylene and vinyl acetate are transferred to the polymerization vessel in the presence of azo compounds and proxides used as catalysts. The described process has a total duration of 6 hours.

A disadvantage of most of the known methods for production of ethylene-vinyl acetate (EVA) copolymers is that it is carried out in an emulsion medium and with stepwise feeding of ethylene and vinyl acetate.

The structure of the classic ethylene-vinyl acetate (EVA) copolymers also known as poly (ethylene-vinyl acetate) (PEVA) is characterized by a certain tact, i.e. sequence of vinyl acetate units with respect to the ethylene chain.

In addition, the known EVA copolymers are isotactic, which means that the vinyl acetate substituents are located on one side of the ethylene chain, as shown in FIG. 1.

### SUMMARY

A problem of the present invention is the production, through addition polymerization, of poly (ethylene-vinyl acetate) copolymer directly from polyethylene and vinyl acetate, with the maximum limited participation of additional reagents.

The problem of the invention is solved by a five-step method for preparing poly (ethylene-vinyl acetate) copolymer with a non-specific spatial configuration of the vinyl acetate units with respect to the basic ethylene chain, which is realized within 2 to 4 hours.

According to the method of the present invention, during the process carried out in a chemical reactor with recycle, melt addition polymerization of primary or secondary polyethylene (LDPE or HDPE) and vinyl acetate (VAM) occurs in the presence of sodium persulphate as initiator of the copolymerization process.

According to the invention, the method involves the simultaneous introduction of the starting reagents in a quantitative ratio of vinyl acetate to polyethylene in weight percentages between 5 and 45. The amount of the polymerization initiator used is in quantitative ratio to the polymer (LDPE or HDPE) in weight percentages between 0.5 and 1.5.

The addition polymerization according to the process described in the invention is carried out during the recirculation process through the mixture system of steam/gas emissions of the substances involved in the polymerization process until the complete exhaustion of the starting reagents and therefore, self-termination of the polymerization process.

The liquid reaction mixture initially obtained after loading the starting reagents is gradually heated, with continuous stirring, to temperatures of 180° C. to 250° C., whereby simple molecular emissions of vapors are released into the reaction mixture, forming a multicomponent vapor/gas mixture over the liquid reaction medium. As the concentration of vapor/gas mixture increases, the pressure in the formed reaction zone increases between 2 and 5 atmospheres. After reaching a certain pressure value, the heated gases from the steam/gas mixture are directed to and pass through the absorption-diffusion zone by high-speed diffusion, further increasing the pressure during its acceleration between 150 and 250 atmospheres. The heated steam/gas mixture is then directed to a low-pressure adsorption-condensation zone with intensive heat exchange. In this zone, the heated steam/gas mixture speed slows down and it cools down, sharply reducing its volume, whereby the constituent substances therein condense separately on a rectification principle, localizing in different locations in the absorption-condensation zone. However, due to the continuous flow of heated gases from the high pressure zone, the resulting vinyl acetate condensates gradually heat up again, absorbing the condensate temperature of the polymer, evaporate and gradually increase the pressure in the absorption condensation zone to values above 5 atmospheres. In addition, the resulting pressure difference between the adsorption-condensation zone and the reaction zone allows the return of a mixture of polymeric condensates and unreacted vinyl acetate back to the reaction zone, where the concentration of the reaction product from the addition polymerization of polyethylene and vinyl acetate gradually increases and part of the unreacted starting materials, joining the vapor/gas mixture in the reaction zone circulating in a new cycle through the absorption-diffusion and absorption-condensation zones to the reaction zone.

This recirculation continues until the complete exhaustion of the starting reagents initially introduced into the reaction zone for 2 to 4 hours, after which the addition copolymerization is self-terminated, the reaction zone is cooled down and the pressure inside the zone drops to 2 atmospheres.

The resulting reaction product, i.e. poly (ethylene-vinyl acetate) copolymer is removed from the chemical reactor.

The physicochemical parameters of the grafted poly (ethylene-vinyl acetate) copolymers produced by the method described herein depend on the polyethylene and vinyl acetate ration vary within 5 and 45% by weight of vinyl acetate against polyethylene varies, as follows: tensile strength according to EN ISO 725-2 σ_{tensile.strength} between 14 MPa and 30 MPa; Charpy impact test with notch between 28 kJ/m² and 50 kJ/m²; specific elongation ε_{specific} between 130% and 380%; density between 0.90 g/cm³ and 0.93 g/cm³; Shore hardness between 98 Shore A and 67; melting point between 137° C. and 158° C.; and Vicat softening temperature between 50° C. and 59° C.

### BRIEF DESCRIPTION OF THE DRAWINGS

FIG. 1 illustrates the general structural formula of a classic EVA copolymer.

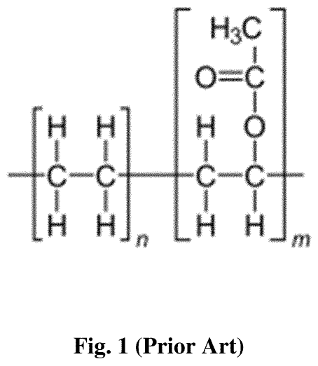

FIG. 2 shows the infrared spectrum of the poly (ethylene-vinyl acetate) copolymer produced using the method of the invention.

FIG. 3. illustrates the random configuration of the graft copolymer between polyethylene and vinyl acetate produced using the method of this invention.

### DETAILED DESCRIPTION

During the first step of the process described herein, primary or secondary polyethylene (LDPE or HDPE) is gradually heated to melt and is supplied in the form of a melt into the reaction zone in a chemical reactor with recycle, where vinyl acetate is introduced simultaneously with the molten polymer (VAM) and sodium persulfate as an initiator of the addition copolymerization process between polyethylene and vinyl acetate.

The liquid medium in the reaction zone is heated while continuous stirred by a mixer built in the chemical reactor.

As the temperature in the reaction zone gradually increases, the pressure increases proportionally. Due to the low boiling point of vinyl acetate, the pressure in the reaction zone is rapidly increased, and at temperatures up to 150° C. the pressure reaches the value of 2-3 atmospheres.

During the second step of the process of this invention, the temperature in the chemical reactor with recycle (autoclave type, with integrated heating coil) is gradually increased until temperatures between 180° C. and 250° C. and pressures between 4 and 5 atmospheres are reached, and until reaching the maximum concentration of the multicomponent vapor/gas mixture above the liquid reaction medium in the reactor formed by simple molecular emissions from the vapors of the starting materials.

While the temperature and pressure increase in the gaseous and liquid media in the reaction zone, the substance diffusion rate increases altogether both as a result of the molecular diffusion and the general convection of the medium as a whole. The continuous stirring of the liquid mixture in the reaction zone significantly accelerates these processes.

After reaching the specific pressure value in the reaction zone, the heated multicomponent steam/gas mixture is directed and diffused at high speed through the absorption-diffusion zone (realized in a channel diffuser equipped with a non-return valve for back pressure), in which the gas acceleration further increases the pressure between 150 and 250 atmospheres, to the absorption-condensation zone that is realized in a heat exchanger-cooler with expanding diameter, which leads to a drop in the speed of the gases and an increased heat exchange.

During the formation, heating and diffusion of the vapor/gas mixture through the absorption-diffusion zone under the above conditions of the process (temperature and pressure), sodium persulfate is activated as a polymerization initiator, which, after probably undergoing chemical decomposition, facilitates the formation of C—C double bonds along the polyolefin macro chain, to which the vinyl acetate is grafted.

During the third step of the method descrived in this invention, the heated multicomponent steam/gas mixture reaches the adsorption-condensation zone, where it slows down (passing through a rectifier), cools down and sharply reduces its volume, whereby the constituent substances condense separately according to the rectification principle, locating in different locations in the absorption-condensation zone. At the bottom of the horizontal heat exchanger, polymer vapors, which have a higher boiling point, and a part of the vinyl acetate vapor condense, and the remaining non-condensing vinyl acetate vapors, which have a lower boiling point, pass to the upper part of the heat exchanger, where they are cooled and condensed.

During the fourth step of the process subject to the present invention, due to the continuous flow of heated gases from the high pressure zone, the resulting vinyl acetate condensates are gradually reheated, absorbing heat from the polymer condensate, and evaporated, i.e. appear to some extent in the role of a cooling agent of the medium in the absorption-condensation zone, where condensation and evaporation processes continuously take place in parallel.

The new evaporation of the vinyl acetate condensates in the heat exchanger, which as an endothermic, heat exchange absorption process, helps lowering the temperature in the heat exchanger, meanwhile leading to a gradual increase of the pressure in the absorption-condensation zone to values above 5 atmospheres.

When the pressure values in the heat exchanger are higher than 5 atmospheres, the mixture of polymer vapor/gas condensates and unreacted vinyl acetate passes through a non-return valve and enters the upper part of the chemical reactor, then enters the reaction zone, where it is heated up again. In addition, the concentration of the poly (ethylene-vinyl acetate) copolymer, i.e. the reaction product of the addition polyethylene and vinyl acetate copolymerization is gradually increased in the liquid reaction medium and a part of the still unreacted starting materials recirculates in a new cycle through the absorption-diffusion and absorption-condensation zones to the reaction zone after joining the vapor/gas mixture in the reaction zone, i.e. cyclically repeat the second, third and fourth of the above-described steps of the invention process.

During the fifth stage of the invention process, within 2-4 hours from its start, the starting reagents that have entered the reaction zone are exhausted, the pressure inside is reduced to 2 atmospheres and the temperature is decreased. Under these conditions, the recirculation diffusion of the vapor/gas mixture from the reaction zone to the absorption-diffusion zone is stopped, the copolymerization process is completed, and the poly (ethylene-vinyl acetate) copolymer produced as a reaction product will is removed from the system.

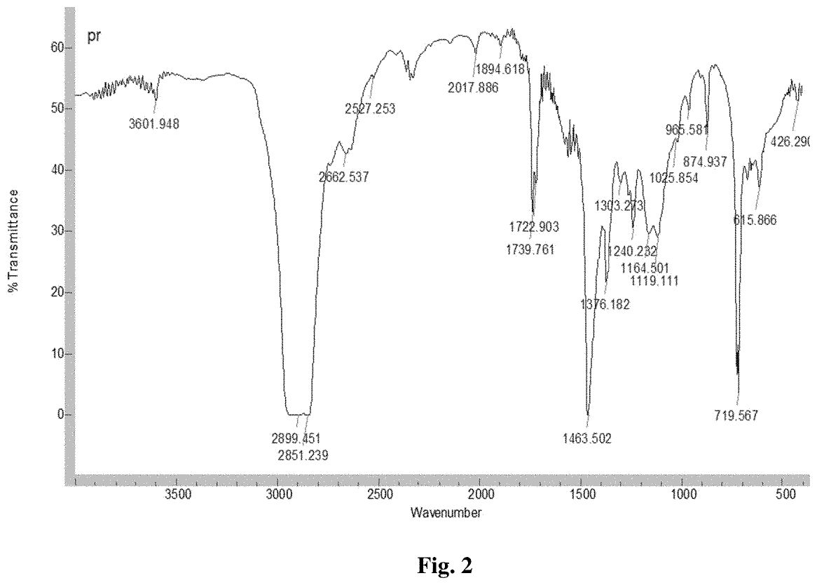

The structure of the copolymers produced according to the method of this invention was examined by means of infrared spectroscopy using Fourier transform and the result obtained is presented in FIG. 2. The analysis of the captured infrared spectrum of the copolymers produced according to the method of the present invention shows that the 2915 and 2849 cm⁻¹ bands correspond to symmetrical and asymmetrical oscillations of the methylene groups of the basic polyethylene chain; the 1740 cm⁻¹ band refers to the ester group of vinyl acetate; the 1463 cm⁻¹ band refers to a methylene group; the bands in the range of 1304-1021 cm⁻¹ refer to the deformation oscillations for the carbonyl group of vinyl acetate; the 964 cm⁻¹ band refers to the double C—C bond of vinyl acetate.

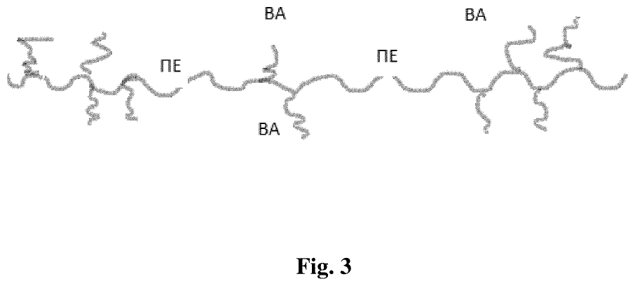

As a result, it may be concluded that the poly (ethylene-vinyl acetate) copolymers produced using the process of the present invention have a non-specific spatial configuration of the vinyl acetate units with respect to the basic ethylene chain, in particular a probable random configuration of distribution of the vinyl acetate units along the length of the main polyethylene chain may be assumed, as shown schematically in FIG. 3, which means that unlike the known EVA copolymers, vinyl acetate units are not evenly and/or periodically distributed along the polyethylene chain in the graft copolymers between polyethylene and vinyl acetate produced according to the method of the present invention.

The Advantages of Method According to the Innovation Are:

The main advantages of the method and the poly (ethylene-vinyl acetate) with a non-specific spatial configuration produced using the method of this invention, are as follows:
multiple reduction of energy consumption compared to the known methods of poly (ethylene-vinyl acetate) copolymer production;
maximum limitation of the type and quantity of additional chemical reagents involved in the method, and hence increase of its efficiency and environmental friendliness;
possibility for use as a raw material of secondary polyethylene, ie possibility for regeneration;
virtually complete elimination of the presence of any destructive structures in the resulting poly (ethylene-vinyl acetate) copolymer, even when secondary polyethylene is used as a raw material for its production.

Enbodyment of the Invention

The following examples illustrate the invention without any limitations.

The data given in the examples are for poly (ethylene-vinyl acetate) copolymers produced in a chemical reactor with recycle, with a volume of 1,173 m³.

### EXAMPLE 1

3 kg primary polyethylene (LDPE) preheated to liquefation, 150 ml vinyl acetate (VAM) and 45 g sodium persulfate are simultaneously loaded. The temperature in the reaction zone is gradually increasing to 190° C., while constantly stirring the liquid medium, in order to start gas recirculation until the completion of the copolymerization process within 2 hours.

3.1 kg high molecular weight poly (ethylene-vinyl acetate) copolymer with the following qualitative and physicochemical parameters is produced: 5 wt. % content of vinyl acetate to polyethylene; tensile strength according to EN ISO 725-2 σ_{tensile.strength}=30 MPa; Charpy impact strength with notch σᵢₘₚ=28 kJ/m²; relative elongation εᵣₑₗ=130%; density 0.93 g/cm³; Shore hardness=98 Shore A; melting point tₘₑₗₜ=158° C.; and Vicat softening temperature 59° C.

### EXAMPLE 2

3 kg primary polyethylene (LDPE) preheated to liquefation, 1200 ml vinyl acetate (VAM) and 45 g sodium persulfate are simultaneously loaded. The temperature in the reaction zone is gradually increasing to 250° C., while constantly stirringing the liquid medium, in order to start gas recirculation until the completion of the copolymerization process within 4.5 hours.

4.1 kg high molecular weight polymer with the following qualitative and physicochemical parameters is produced: 40 wt. % content of vinyl acetate to polyethylene; tensile strength according to EN ISO 725-2 σ_{tensile.strength}=15 MPa; Charpy impact strength with notch σᵢₘₚ=48 kJ/m²; relative elongation εᵣₑₗ=370%; density 0.91 g/cm³; Shore hardness=69 Shore A; melting point tₘₑₗₜ=139° C.; and Vicat softening temperature 48° C.

1-11. (canceled)

12. A method of poly (ethylene-vinyl acetate) copolymer production, with a non-specific spatial configuration of the vinyl acetate units relative to the main ethylene chain, wherein primary or secondary polyethylene and vinyl acetatein are simultaneously loaded in a chemical reactor preheated to the melting point of the primary or secondary polyehilene and vinyl acetate in a ratio 5-45 weight percentages, as well as sodium persulfate as an initiator of addition polymerization in a quantitative ratio to the polymer between 0.5 and 1.5 weight percentages, after which the resulting liquid reaction mixture is gradually heated, while continuously stirring, to temperatures between 180 and 250° C., whereby simple molecular vapor emissions of the substances in the reaction mixture are released, thus forming a multicomponent vapor/gas mixture with increasing concentration, while the pressure in the reaction zone thus formed is increased between 2 and 5 atmospheres, followed by high-speed diffusion of the heated vapor/gas mixture directed through an absorption-diffusion zone, with a constant acceleration, increasing the inside pressure between 150 and 250 atmospheres, to a low-pressure absorption-condensation zone, where the heated vapor/gas mixture reduces its speed, cools down and sharply reduces its volume, as the constituent substances inside condense separately according to a rectification principle, localizing at different locations in the absorption-condensation zone, followed by gradual reheating and evaporation of the vinyl acetate condensates due to the continuous inflow of heated gases from the high pressure zone and heat absorption from the polymer condensate leading to a gradual increase in pressure in the absorption-condensation zone to values above 5 atmospheres, followed by the return of polymer condensates and unreacted vinyl acetate mixture back to the reaction zone, where the concentration of the reaction product of the addition polyethylene and vinyl acetate polymerization is gradually increased in the reaction medium, and the part of non-reacting starting materials joining the vapor/gas mixture in the reaction zone recirculates in a new cycle through the absorption-diffusion and absorption-condensation zones to the reaction zone until the complete exhaustion of the reagents that have initial entered the reaction zone and the self-termination of the addition copolymerization process within 2-4 hours.

13. The method according to claim 12, wherein the primary or secondary polyethylene used may be LDPE or HDPE, or their mixture.

14. A poly (ethylene-vinyl acetate) copolymer with a non-specific spatial configuration of the vinyl acetate units relative to the main ethylene chain, produced according to the method specified in claim 12, for a duration between 2 and 4 hours, by means of melt addition polymerization of primary or secondary polyethylene and vinyl acetate, in a ratio of vinyl acetate to polyethylene between 5 and 45 weight percentages, carried out in a chemical reactor with recycle, at temperatures between 180 and 250° C. and pressure in the reaction zone between 2 and 5 atmospheres, further assisted by the increased pressure in the absorption-diffusion zone within 150-250 atmospheres, in the process of recirculation of a multicomponent vapor/gas mixture from the reaction zone through the adsorption-diffusion zone to the absorption-condensation zone, and back to the reaction zone, also carried out in the presence of sodium persulfate as initiator of polymerization, in a ratio between 0.5 and 1.5 weight percentages to the polyethylene introduced, where the poly (ethylene-vinyl acetate) copolymer produced has the following physicochemical parameters: tensile strength according to EN ISO 725-2 σ_{tensile.strength} between 14 MPa and 30 MPa; Charpy impact test with notch between 28 kJ/m² and 50 kJ/m²; specific elongation ε_{specific} between 130% and 380%; density between 0.90 g/cm³ and 0.93 g/cm³; Shore hardness between 98 Shore A and 67; melting point between 137° C. and 158° C.; and Vicat softening temperature between 50° C. and 59° C.

15. A bitumen modifier comprising the poly (ethylene-vinyl acetate) copolymer with a non-specific spatial configuration according to claim 14.

16. A powder polymeric concrete modifier comprising the poly (ethylene-vinyl acetate) copolymer with a non-specific spatial configuration according to claim 14.

17. A building unit for polymer construction materials and elements comprising the poly (ethylene-vinyl acetate) copolymer with a non-specific spatial configuration according to claim 14.

18. A method of foam profiles manufacturing comprising using the poly (ethylene-vinyl acetate) copolymer with a non-specific spatial configuration according to claim 14.

19. A method of polyvinyl alcohol copolymer manufacturing comprising using the poly (ethylene-vinyl acetate) copolymer with a non-specific spatial configuration according to claim 14.

20. A method for hot melt adhesives manufacturing comprising using the poly (ethylene-vinyl acetate) copolymer with a non-specific spatial configuration according to claim 14.

21. The poly (ethylene-vinyl acetate) copolymer with a non-specific spatial configuration according to claim 14, wherein the poly (ethylene-vinyl acetate) copolymer is compatible to polyolefin.

22. A bitumen insulation polymer comprising the poly (ethylene-vinyl acetate) copolymer with a non-specific spatial configuration according to claim 14.

23. A polymer for waterproofing comprising the poly (ethylene-vinyl acetate) copolymer with a non-specific spatial configuration according to claim 14.
